(19) United States
(12) Patent Application Publication
(10) Pub. No.: US 2022/0212159 A1
(43) Pub. Date: Jul. 7, 2022

(54) PROCESS OF SYNTHESIS OF SILICA-BASED ADSORBENTS, ADSORBENTS AND USE

(71) Applicants: PETROLEO BRASILEIRO S.A.- PETROBRAS, Rio de Janeiro (BR); INSTITUTO NACIONAL DE TECNOLOGIA - INT, Rio de Janeiro (BR)

(72) Inventors: Cristina PONTES BITTENCOURT QUITETE, Rio de Janeiro (BR); Elise MOTA DE ALBUQUERQUE, Rio de Janeiro (BR); Simone DE JESUS CANHACI, Petropolis (BR); Leon Fagner FEITOSA, Rio de Janeiro (BR); Marco Andre FRAGA, Rio de Janeiro (BR)

(21) Appl. No.: 17/541,672

(22) Filed: Dec. 3, 2021

(30) Foreign Application Priority Data
Dec. 4, 2020 (BR) 1020200248812

(51) Int. Cl. B01J 20/10; B01J 20/02; B01J 20/04; B01J 20/30; B01D 53/02

(52) U.S. Cl. CPC B01J 20/103; B01J 20/0211; B01J 20/0248; B01J 20/0237; B01J 20/0251; B01J 20/04; B01D 2257/504; B01J 20/3078; B01D 53/02; B01J 2220/4812; B01J 2220/42; B01D 2253/106; B01J 20/3071

(57) ABSTRACT

The present invention relates to a process of synthesis of silica-based adsorbents used in the CO₂ capture process in oil fields with expressive volumes of associated CO₂, aiming its subsequent use in processes of producing bioQAV and alcohol from the hydrogenation reaction. Adsorbents obtained based on silica and different metals have a high stability and activity in CO₂ capture, at adsorption and desorption temperatures of 25° C., increasing the density of the silanol groups present in mesoporous silica, conducted by replacing Si in the crystal lattice with various metals. The insertion of elements in the structure is responsible for creating vacancies used to capture CO₂, being characteristic of higher enthalpies involved in the process. Additionally, the exchange of silicon for metals is conducted during the hydrolysis process of the silica precursor, not requiring another step, in addition to being able to be conducted with low-cost precursors, such as chlorides, nitrates and isopropoxides, and an aqueous medium.

### FIELD OF INVENTION

The present invention relates to a process of synthesis of silica-based adsorbents used in the CO₂ capture process with application in oil fields with expressive volumes of associated CO₂, aiming its subsequent use in processes of producing bioQAV and alcohol from the hydrogenation reaction.

### DESCRIPTION OF PRIOR ART

The main initiatives to mitigate CO₂ emissions are emission control, increased energy efficiency in processes, replacement in the energy matrix with low-carbon processes and CO₂ capture and storage (CO₂ Capture and Storage—CCS).

The most commonly used processes for CO₂ capture are cryogenic distillation, membrane purification and adsorption on adsorbent liquids and solids. These technologies have disadvantages, such as low temperatures for cryogenic distillation and the limited scale for the use of separation membranes. In addition, solvent absorption, in addition to being costly, is highly corrosive, in addition to losses due to degradation and evaporation, requiring large make-up volumes. A viable alternative is the use of adsorbent solids, whose energy consumption is low, in addition to the possibility of regeneration, reusing the adsorbent in various adsorption-regeneration cycles.

Alkali oxides, or materials containing alkali metals, such as CaO, MgO, LiSiO₄, are among the most used adsorbents, in processes that occur at elevated temperatures, such as gasification and combustion, since adsorption can be conducted at temperatures above 500° C. The main technical problem refers to sintering, affecting the durability of adsorbents. To improve the strength, supports are used, such as carbon, aluminas, aluminates and silica, or additives such as Ce, Y, La, among others, are used, as described by GAO, N.; CHEN, K.; QUAN, C. “Development of CaO-based adsorbents loaded on charcoal for CO₂ capture at high temperature”, Fuel, vol. 260, 116411, 2020.

Adsorbents based on hydrotalcites or anionic clays (hybrid lamellar materials) are frequently mentioned in literature, but they may present loss of efficiency, due to the lack of thermal stability over time. These solids have great flexibility, since they can employ different divalent (Mg²⁺, Zn²⁺, Ni²⁺) e trivalent (Al³⁺, Ga³⁺, Fe³⁺, Mn³⁺) metals and anions (CO₃²⁻, Cl⁻ and SO₄²⁻) in their composition. As the textural property is a principal factor in the adsorption capacity, preparation methods that increase the specific area are sought. Co-precipitation at controlled pH using NaOH or Na₂CO₃ and precursors of metal salts (nitrates) produces materials having low area. For example, the use of hydrothermal treatment after precipitation, with a delamination step with formamide, as described by SHANG, S. et al. “Novel M (Mg/Ni/Cu)—Al—CO₃ layered double hydroxides synthesized by aqueous miscible organic solvent treatment (AMOST) method for CO₂ capture”, Journal of Industry and Engineering Chemistry, v. 373, p. 285-293, 2019, or dispersion of the precipitate in acetone for a long period, which induces an increase in the area, adsorbing about 40 mg 002/g ads at 200° C., with desorption at 400° C., as referenced by WANG, J. et al. “Layered double hydroxides/oxidized carbon nanotube nanocomposites for CO₂ capture”, Journal of Industry and Engineering Chemistry, v. 36, p. 255-262, 2016.

The functionalized materials, such as SBA-15 and MCM-41 silicas, have as their main disadvantage the preparation method, which involves several steps and uses expensive reagents for functionalization, such as: 2-amino-2-methyl-1-propanol (AMP) and triethylenetetramine (TETA), making the production process more expensive. The results obtained with mesoporous materials functionalized with amines are in the order of 88 mg 002/g ads (adsorption at 75° C.), but the amount of amine impregnated in the material is in the order of 50% as taught by ÜNVEREN, E. E. et al., “Solid amine sorbents for CO₂ capture by chemical adsorption: A review”, Petroleum, v. 3, p. 37-50, 2017.

These impregnations with high amounts can compromise the desorption cycle, in addition to increasing the fragility of the structure, by increasing the pores, as the walls of the porous network tend to become thinner, reducing the stability of the system. The same happens when impregnating substrates with polyethyleneimines such as PEI (SON, W. J. et al., “Adsorptive removal of carbon dioxide using polyethyleneimine-loaded mesoporous silica materials”, Microporous and Mesoporous Materials, v. 113, p. 31-40, 2008; WEI, J. et al., “Capture of carbon dioxide by amine-impregnated as-synthesized MCM-41”, Journal of Environmental Science, v. 22, p. 1558-1563, 2010). Another class of materials that also presents satisfactory results, in the range of 88 mg 002/g, are the MOFs (Metal-Organic Frameworks), being common the use of Mg, Zr, Zn, but the synthesis of MOFs, besides being complex, uses expensive reagents, making its wide use unfeasible according to the documents WO2010148276A2 and US2014/0322123.

The reactivity of zirconium hydroxide has been attributed to the presence of hydroxyls, the presence of defects (“oxygen vacancies”) and the presence of acidic and basic Lewis and Brönsted sites. The presence of oxygen vacancies provides the formation of more thermally stable adsorbed species of CO₂ requiring higher temperatures to desorb, according to the references by ZELENAK, V. et al. “Insight into surface heterogeneity of SBA-15 silica: Oxygen related defects and magnetic properties”, Colloids and Surfaces A: Physicochemical and Engineering Aspects, v. 357, p. 97-104, 2010; TUMULURI, U. et al. “Effect of surface structure of TiO₂ nanoparticles on CO₂ adsorption and SO₂ resistance”, ACS Sustainable Chemistry & Engineering, v. 5, p. 9295-9306, 2017; SLOSTOWSKI, C. et al. “CeO₂ nanopowders as solid sorbents for efficient CO₂ capture/release processes”, Journal of CO₂ Utilization v. 20, p. 52-58, 2017. Zirconium is an element that can also be used for CO₂ adsorption in materials such as Li₂ZrO₃. However, this class of materials requires high desorption temperatures; for example, solid Li₂ZrO₃ is only reactivated above 700° C., being more suitable for use in automotive systems as described in document US2013/0174739A1. It is emphasized that many metal hydroxides react spontaneously with CO₂ forming species such as bicarbonates, carbonates and even carboxylates with distinct types of bidentate, monodentate, polydentate linkages, among others, according to studies by BALOW, R. B. et al. “Environmental effects on zirconium hydroxide nanoparticles and chemical warfare agent decomposition: implications of atmospheric water and carbon dioxide”, ACS Applied Materials & Interfaces, v. 9, p. 39747-39757, 2017. Despite being simple to prepare, they have the disadvantage of the volume of material in the adsorption bed in the desorption steps at higher temperatures, in addition to the loss of capture capacity due to crystallographic changes in the material, such as the formation of oxides.

The emission of CO₂ is a critical issue since the increase in its concentration causes an increase in the temperature of the Earth's surface. There are reports that if the CO₂ concentration, currently at 414 ppm, rises to the range of 600-700 the temperature could increase by as much as 5.0° C. Additionally, in the oil industry, due to the pre-salt, significant volumes of CO₂ are associated with reservoirs. The capture of this gas would allow its subsequent use in synthesis processes, such as in the production of bioQAV and alcohols from the hydrogenation reaction.

U.S. Pat. No. 9,381,491B2 discloses a material for processing carbon dioxide and a method for adsorbing and/or converting carbon dioxide using a ceramic material. The use of the SBA compound, especially the SBA-15, in which the porous silicon dioxide material SBA-15 can serve as a template used in the high sintering process. The SBA-15 has a high specific surface area and, while heating up to 1,000° C., it has a stable structure and a porous property. Thus, after being used as a sintering template, the SBA-15 can be removed by an alkaline solution (e.g., sodium hydroxide solution) to produce the ceramic material with a high specific surface area. The ceramic material with the high specific surface area comes with more oxygen vacancies, allowing the ceramic material to have a selective ability to adsorb carbon dioxide when in the presence of other compounds. However, this document does not mention a modification of SBA with Mg and Cu, as well as the methodology and their respective concentrations, in the preparation of SBA-15.

Document US20130294991A1 relates to the use of a means of removing unwanted species from a process stream comprising introducing heteroatoms into a silica matrix loaded with polymeric amines. The use of adsorbent to capture species comprises, in a structure of silica nanoparticles, poly(ethyleneimine) (PEI) and heteroatoms selected from the group consisting of atoms of Zr, Ti, Fe, Ce, Al, B, Ga, Co, Ca, P and Ni. The PEI can be a low molecular weight branch and the structure can be SBA-15. The modification of SBA-15 occurs with Zr, not mentioning the Mg and Cu compounds.

Document US20150251160A discloses a method of preparing an adsorbent that includes a hierarchically porous silica monolith and particularly an adsorbent for adsorbing or separating carbon dioxide in air or heavy metals in an aqueous solution, in which an amino group is covalently bonded to silica monolith, wherein the silica monolith is selected from the group consisting of SBA-15, SBA-16, SBA-12, MCM-41, MOM-48, FSM-16, FDU-1, FDU-12 and KIT-5. Furthermore, it uses the compounds TEOS and P123 in its methodology, but it does not specify a modification of SBA with Mg and Cu.

Thus, no prior art document reveals an increase in CO₂ capture using materials having different silica and different metal ratios such as that of the present invention.

In order to solve such problems, the present invention was developed, through the high stability of the silica-based adsorbent and activity in CO₂ capture, at low adsorption and desorption temperatures.

The insertion of elements in the structure of the adsorbent is responsible for the creation of vacancies used to capture CO₂, thus increasing the density of the silanol groups present in mesoporous silica, through the replacement of silica in the crystal lattice with several metals.

### BRIEF DESCRIPTION OF THE INVENTION

The present invention relates to a process for the synthesis of silica-based adsorbents used in the process of capturing CO₂ in oil fields with expressive volumes of CO₂ associated, aiming at its subsequent use in synthesis processes, such as fuel and hydrogen production, if used for dry reforming, that is, hydrocarbons reacting with CO₂, or for injection into reservoirs.

Adsorbents obtained based on silica and different metals have as a differential the high stability and activity in capturing CO₂, at adsorption and desorption temperatures at 25° C., although the material does not suffer structural damage at higher temperatures (up to 400° C.). The adsorption capacity is increased with the increase in density of silanol groups present in mesoporous silica, conducted by replacing Si in the crystal lattice with several metals, such as Cu⁺², Al⁺³, Mn⁺⁴, Ni⁺², Mg⁺², Sn⁺⁴, Zr⁺⁴, Co⁺², Pt⁺⁴, among others. The insertion of elements in the structure is responsible for creating vacancies that can be used to capture CO₂, being characteristic of higher enthalpies involved in the process.

Additionally, the exchange of silicon for metals is conducted during the hydrolysis process of the silica precursor, not requiring another step, in addition to being able to be conducted with low-cost precursors, such as chlorides, nitrates and isopropoxides, and an aqueous medium.

### BRIEF DESCRIPTION OF THE DRAWINGS

The present invention will be described in more detail below, with reference to the attached figures which, in a schematic and non-limiting way, represent examples of the configuration thereof. In the drawings, there are:

FIG. 1 illustrating a graph of the density of silanols versus adsorption capacity at 25° C.,

FIG. 2 illustrating a graph of mass loss at 100° C. versus adsorption capacity at 25° C.,

FIG. 3 illustrating a graph of adsorption at 25° C. conducted in cycles;

FIG. 4 illustrating a graph of the thermogravimetric analysis of sample A.

### DETAILED DESCRIPTION OF THE INVENTION

The process of synthesis of adsorbents based on silica and different metals, according to the present invention, comprises the following steps:

a) complete dissolution of the poly(ethylene glycol)-poly(propylene glycol)-poly(ethylene glycol) surfactant in block (P123) having Mw=5800, in a 37% HCl solution with a pH range between 0.15 and 1.5 for 0.5-4 hours at 35-40° C.;

b) adding a metal precursor such as chlorides, nitrates and isopropoxides in aqueous medium in the amount of 1 mol TEOS for 0.02-0.30 mol of the metal precursor;

c) after 30 minutes adding tetraethoxysilane (TEOS) and keeping the mixture at 35-40° C. for 20-24 hours;

d) transferring the material to a sealed reactor to conduct the hydrothermal treatment, placing it inside an oven adjusted to 100-120° C., keeping it in this condition for 20-48 hours;

e) cooling the material to room temperature, filtering and washing with distilled water and a 2% v/v solution of hydrochloric acid in ethanol;

f) after the washing step, dry the material at 35-60° C. for 6-24 hours and calcinate at 500-550° C. using a rate of 1-5° C./min for 4-6 hours.

The metal precursor can be chlorides, nitrates and isopropoxides chosen among the metals Cu, Mg, Al, Mn, Ni, Sn, Zr, Co or Pt.

The employed ratios for silica/metal (Si/M) range from 8 to 60.

The adsorbents obtained by the present invention present Si/M ratio between 8 to 60, adsorption at 25° C. in the range of 40 to 112 mg 002/g ads, area in the range of 520 to 840 m²/g, dp in the range of 60-92 angstrom/pore volume*cm³/g, silanol density in the range from 4.8 to 24 SiOH*nm² and enthalpy at 25° C. in the range from 607 to 1938 J/g.

### EXAMPLE

For this work, tests were carried out as follows, which represent examples of embodiments of the present invention.

### Example 1: Capture and Enthalpy Results Using Silica-Based Solids (Si/Mg and Si/Cu Equal to 10 and 20)

The CO₂ capture method using the Mettler Toledo thermogravimetric scale (TGA/SDTA 851E), contains the following steps: 1) 25-100° C./10° C./min argon; 2) 100° C.-60 min/Argon; 3) 100° C.-25° C.-10° C./min/argon; 4) 25° C.-150 min-CO₂, 5) 25° C.-150 min argon.

The methodology used was as follows: after the complete dissolution of the surfactant (poly(ethylene glycol)-poly(propylene glycol)-poly(ethylene glycol)-P123) (Mw=5800), in HCl solution (37%, with pH=<1,0) for 4 hours at 40° C., the Mg chloride or Cu chloride was added in the desired amounts, according to the stoichiometry (1TEOS: 0.016P123: 5.7HCl: 193H₂O: 0.1 Cu or Mg chloride, or 1TEOS: 0.016P123: 5.7HCl: 193H₂O: 0.105 Cu or Mg chloride) after 30 minutes, tetraethoxysilane (TEOS) was added, and the mixture was kept at 40° C. for 24 hours. The material was then transferred to a sealed reactor to conduct the hydrothermal treatment, and placed inside an oven adjusted to 120° C., keeping this condition for 48 hours. The material was cooled to room temperature, filtered and washed with distilled water and a 2% v/v solution of hydrochloric acid in ethanol. After the washing step, the material was dried at 60° C. for 6 hours and calcinated at 550° C. using a rate of 5° C./min, keeping at 550° C. for 6 hours.

All these samples show a high pore volume, approximately 1.0 cm³/g, predominantly presenting mesoporosity, which helps in the adsorption of CO₂.

Infrared analysis of the samples showed absorption bands around 800 and 1,070 cm⁻¹, attributed to the symmetrical and asymmetrical elongation of the Si—O—Si bond.

The absorptions at 3,600 cm⁻¹ and 1,640 cm⁻¹ are characteristic of the OH— bond of water; those of 3,740 cm⁻¹ and 962 cm⁻¹ are due to silanol groups (Si— OH), and that precisely the presence of silanols (Si—OH binding) helps in CO₂ removal.

The literature of TAHARI, M. N. A.; YARMO, M. A. “Adsorption of CO₂ on silica dioxide catalyst impregnated with various alkylamine”, AIP Conference Proceedings, v. 1614, p. 334, 2014 teaches that the formation of a bond between the silanol group and CO₂ can occur at 2,333 cm⁻¹.

In general, the density of silanols in a silicate tends to range from 1-5 OH nm⁻², depending on the method of preparation used, as described in BOUCHARD, J. et al. “Characterization of depolymerized cellulosic residues”, Wood Science and Technology, v. 23, p. 343-355, 1989. The adsorption capacity of adsorbents can be increased by increasing the density of the silanol groups present in mesoporous silica, conducted by replacing Si in the crystal lattice with various metals, such as: Al⁺³, Mn⁺⁴, Ni⁺², Mg+2, Sn⁺⁴, Zr⁺⁴, Co⁺², Pt+4, etc. Additionally, the insertion of elements into the structure is responsible for creating vacancies that can be used to capture CO₂.

Table I presents the result of adsorption, textural properties and the density of silanols, it can be seen that the amount of silanols is close, which explains the adsorption results, all being in the order of 40 mg CO₂/g, a result obtained for the sample of microporous commercial carbon (A=932 m²/g, Dp=37 angstrom).

Although the capture values are close, it is possible to notice that the enthalpy involved in the CO₂ adsorption process is greater for the Si/M ratio=20 (where M is the metal), at about 1,000 J/g, which means that the CO₂ adsorption mechanism is more stable. However, the enthalpy is lower for higher temperatures as shown in Table II for the samples with Si/Mg=20 and Si/Cu=20, indicating that the capture process is more effective at a temperature of 25° C.

TABLE I
Adsorption capacity results at 25° C.

| | | | Dp | Density of | |
|---|---|---|---|---|---|
| | Adsorption | | (angstron)/ | silanols | |
| | at 25° C. | | pore | (nm²)- | Enthalpy |
| | (mg CO₂/ | Area | volume | partially | at 25° C. |
| Adsorbents | g ads) | (m²/g) | * cm³/g) | hydrated | (J/g) |
| S1 | 49 | 617 | 90/1.00 | 6.4 | |
| (Si/Cu = 20) | | | | | |
| S2 | 34 | 697 | 66/1.04 | 4.8 | 1633 |
| (Si/Mg = 20) | | | | | |
| S3 | 40 | 631 | 74/0.97 | 4.9 | 607 |
| (Si/Mg = 10) | | | | | |
| S4 | | | | | |
| (Si/Cu = 10) | 48 | 520 | 72/1.06 | 5.1 | 936 |

TABLE II
Adsorption enthalpy at different temperatures.

| | Enthalpy at | 25° C. | Enthalpy at | 50° C. |
|---|---|---|---|---|
| | 25° C. | (mg_{co2}/ | 50° C. | (mg_{co2}/ |
| Materials | (J/g) | gads) | (J/g) | gads) |
| S1 (Si/Cu = 20) | 1938 | 49 | 648 | 16 |
| S2 (Si/Mg = 20) | 1633 | 34 | 466 | 10 |

### Example 2: Effect of the Amount of Silanols on CO₂ Capture

The CO₂ capture method used the Mettler Toledo thermogravimetric scale (TGA/SDTA 851E), contains the following steps: 1) 25-100° C./10° C./min argon; 2) 100° C.-60 min/Argon; 3) 100° C.-25° C.-10° C./min/argon; 4) 25° C.-150 min-CO₂, 5) 25° C.-150 min argon.

The preparation of silica is similar to that described in EXAMPLE 1, however, it was prepared in HCl solution with pH=1.5 and Al(OiPr)₄. After adding all the reagents, the resulting solution is kept at 40° C. under stirring for 20 hours. The hydrothermal treatment generates a white solid (composite Al-SBA-15-CT) which is separated from the mother solution by filtration, followed by the hydrothermal treatment at 100° C. for 20 hours, being dried in an oven at 35° C. for 24 hours. Calcination is conducted at 500° C. for 5 hours using a heating rate of 1° C.·min⁻¹ and 50 mL·min⁻¹ of compressed air. Through the use of different amounts of Al(OiPr)₄, Si/Al=8, 30 and 60 ratios were obtained.

It is observed that the samples obtained high specific areas, equal to 600 m²/g, 837 m²/g and 816 m²/g. Proof of the SBA-15-type mesoporous structure is evaluated by low-angle X-ray diffraction and transmission electron microscopy techniques, and Al insertion into the lattice is verified by solid state nuclear magnetic resonance (27Al nucleus).

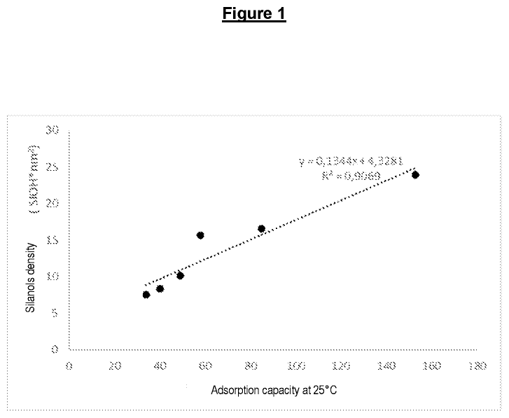

FIG. 1 shows a correlation between the density of silanols (SiOH*nm²) and the result of capture at 25° C. (mg_{CO2}/g), indicating that the higher the density of silanols, the greater the capture of CO₂. The data are from different samples, all obtained by exchanging Si with another type of metal, in this case, Cu⁺², Mg⁺², Al⁺³. It is noteworthy that the proof of the structure of the SBA-15 type is evaluated by a low angle X-ray diffraction test, SAXS.

The presence of silanols is a key factor for the adsorption process, since approximately 80% of the silanols have a pKa around 8.2, being very accessible and being able to interact with CO₂, which is acidic. The preparation, with regard to thermal steps, such as calcination and drying, can preserve the amount of silanols present in silica, which are of three types: vicinal, free and geminal, as reported by BASSO, A. M. et al. “Tunable Effect of the Calcination of the Silanol Groups of KIT-6 and SBA-15 Mesoporous Materials”, Applied Sciences, v. 10, p. 970, 2020; Wang, L.; Yang, R. T. “Increasing Selective CO₂ Adsorption on Amine-Grafted SBA-15 by Increasing Silanol Density”, The Journal of Physical Chemistry, v. 115, p. 21264-21272, 2011.

The deterioration of the silanol groups is relevant with the increase in the calcination temperature, with the geminal silanols being the best preserved. Note that although the calcination temperature used was high, 500 or 550° C., as the samples are not functionalized, that is, the remaining silanol groups were preserved, which partially explains the adsorption result.

### Example 3: Effect of Metal Substitution on Mesoporous Silica Samples

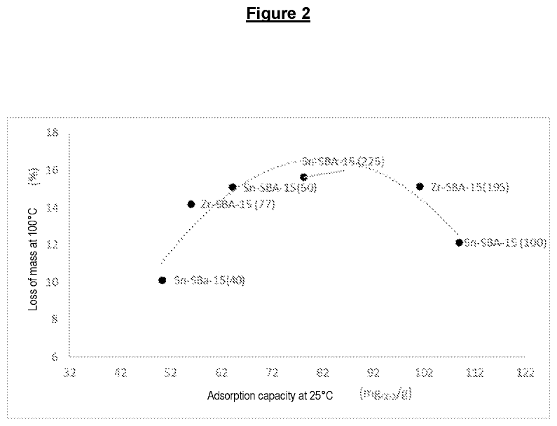

FIG. 2 shows the correlation of mass loss at 100° C. versus adsorption capacity at 25° C., in which only the presence of silanols (indirect measure of silanol density, considering specific nearby areas), does not fully explain the result, since the capture mechanism is not explained only by the insertion of CO₂ in the hydroxyl group, since some samples presented similar values, with different results. The greater the Si replacement, the greater the ability to capture, as well evidenced for the Zr-SBA-15 series.

In the case of Sn, it was observed by analysis of ultraviolet-visible spectroscopy and transmission electron microscopy that SnO₂ would have segregated, which would explain the worse result of Sn-SBA-15 (Si/Sn=40).

The synthesis of Zr-SBA-15 and Sn-SBA-15 materials is similar to that described in EXAMPLE 1 for the Al-SBA-15 family, only differentiated by the addition of a precursor of Zr (zirconium oxychloride) or Sn (tin chloride) together with TEOS in its solubilization step. The masses of the added precursors are calculated in order to obtain different Si/M ratios (M=Zr or Sn). Six new adsorbents with Si/Zr ratios=77, 114, 195 and Si/Sn=40, 100 and 225 were synthesized. The quantities of precursors are adjusted to conduct these syntheses.

Similarly, these samples also showed high specific area: Zr-SBA-15 (Si/Zr=77): 737 m²/g; Zr-SBA-15 (Si/Zr=114): 707 m²/g; Zr-SBA-15 (Si/Zr=195): 722 m²/g; Sn-SBA-15 (Si/Sn=40): 659 m²/g; Sn-SBA-15 (Si/Sn=100): 829 m²/g; Sn-SBA-15 (Si/Sn=225): 873 m²/g. The proof of the mesoporous structure of the SBA-15 type is evaluated by the techniques of low-angle X-ray diffraction and transmission electron microscopy.

The insertion of metals at certain ratios creates oxygen vacancies, used to capture CO₂, which explains the higher enthalpy values of some samples, which is a factor pointed out in the literature as relevant for CO₂ capture. Solids with Zr and Sn, despite capturing a greater amount of CO₂, due to the presence of a greater amount of silanols, can desorb more easily, using lower desorption temperatures.

Note from Table III that solids with lower adsorption enthalpies can desorb more easily, using lower desorption temperatures, which are interesting in the case of SBA-15, with Si/Sn(100) and Si/Al=60, which have enhancers of CO₂ capture values and low enthalpy.

In addition to silanols, the insertion of metals at certain ratios would be creating oxygen vacancies, flaws in the structure, used to capture CO₂, which explains the higher enthalpy values of some samples, which is a factor pointed out in the literature as relevant for CO₂ capture. The creation of oxygen vacancies in mesoporous silica (KCC-1) was confirmed by NMR ²⁹Si, and was generated by modifications in the preparation, as per HAMID, M. Y. S. et al. “Oxygen vacancy-rich mesoporous silica KCC-1 for CO₂ methanation”, Applied Catalysis A: General, v. 532 p. 86-94, 2017. The authors concluded that vacancies favor the adsorption/desorption of CO₂ at temperatures below 473K.

TABLE III
Capture and adsorption enthalpy values at 25° C.

| | Capture of CO₂ at | Adsorption enthalpy at |
|---|---|---|
| Materials | 25° C. (mg_{co2}/g) | 25° C. (J/g) |
| Si/Cu = 10 | 49 | 607 |
| Si/Cu = 20 | 48 | 1938 |
| Si/Mg = 20 | 34 | 1633 |
| Si/Mg = 10 | 40 | 607 |
| Si/Al = 8 | 58 | 590 |
| Si/Al = 30 | 85 | 467 |
| Si/Al = 60 | 153 | 673 |
| Si/Zr (77) | 56 | 731 |
| Si/Zr (14) | 53 | 888 |
| Si/Sn (225) | 78 | 1033 |
| Si/Sn (100) | 109 | 468 |
| Si/Sn (50) | 64 | 677 |
| Si/Sn (40) | 50 | 751 |

### Example 4: Capture of CO₂ with Material Containing Zirconium Hydroxide

Sample A is prepared using the precipitation method, employing zirconia oxychloride (pH=0.69) and H₂PtCl₆.6H₂O (pH=0.63) and ammonium hydroxide (pH=11.77) as a precipitating agent, with a concentration of 14.5% m/m. After completing the addition of the zirconium precursor under zirconia hydroxide, the mother solution is aged (pH=10) at room temperature for 1 hour at rest, the sample is washed until it reaches pH=5, having been dried at 80° C. for 48 hours.

Sample B (Pt=0.1% m/m) was prepared using the precipitation method, using a mixture of zirconia oxychloride and cerium nitrate and H₂PtCl₆.6H₂O (pHmixture=0.39) and ammonium hydroxide (pH=11.73) as a precipitating agent, with a concentration of 14.5% m/m. After the addition of the precursor mixture under ammonia hydroxide, the mother solution was aged (pH=10) at room temperature for 1 h at rest. The sample was washed until it reaches pH=5 and is dried at 80° C. for 20 hours.

In this study, NH₄OH was used and washing was controlled through pH, ending when the washing water had pH=5. The main objective of the synthesis of this type of material called “single-atoms” is to improve the anchoring of Pt in the support, seeking to achieve 100% atomic use, consequently a high metallic dispersion. By reaching smaller particle diameters, it is possible to achieve differentiated properties. Table IV summarizes the results of the five samples evaluated.

TABLE IV
Sample characterization data

| | | Chemisorption of H₂ | | | Diffraction |
|---|---|---|---|---|---|
| | A | A metallic | Dp | | Analysis |
| Samples | (m²/g) | (m²/g_{Pt}) | (nm) | D(%) | (DRX) |
| A the | 187 | 316 | 0.88 | 100 | t-ZrO₂ and |
| base of | | | | | hydrated |
| Zr | | | | | zirconia |
| B the | 192 | 296 | 0.94 | 100 | t-ZrO₂ and |
| base of | | | | | hydrated |
| Zr, Ce | | | | | zirconia |

It can be confirmed that all samples presented high areas and high Pt dispersions, whose classification of the particles found is of the cluster order. But there may be a particle size distribution, unfortunately the particle diameter per chemisorption is an average value. It was not possible to find by XRD, neither Pt species nor cerium species, because the amount of Pt is very low, in addition, the samples were not calcinated. Interestingly, evidence of the species of iron oxide, ferrihydrite, was identified in the samples, which characterizes high specific areas, provided by the modification of the precursor agent, in this case, ammonium hydroxide. And in samples A and B, hydrated zirconia, although they present a typically amorphous profile due to the absence of calcination.

A high specific area is related to the presence of oxygen vacancies, helping to anchor the metal. The capture of CO₂ can benefit as the CO₂ can occupy the oxygen vacancies.

Therefore, there is robust evidence that Pt is well anchored in the prepared solids, due to the area and dispersion results of the metal. Note that sample dispersions with zirconia were better than with iron species, all achieving 100% dispersion. This is in line with the literature, since zirconium oxide is widely used in photochemical applications and reactions involving CO₂, precisely because of the role that oxygen vacancies play in these reaction mechanisms, and in this work, in addition to anchoring Pt, it may be facilitating the capture of CO₂.

Regarding the samples containing Zr, the infrared spectroscopy analysis showed bands related to —OH bonds bonded to zirconia (1552, 1335 and 654 cm−1), band related to the stretching of the OH bond in water (3109 and 1628 cm−1) and stretching the Zr—O bond (654 cm−1). Note that despite the large area, the pore volume of the sample is small, equal to 0.064 cm³/g, the pore volume is considered a relevant factor for CO₂ capture according to document by YILDIZ, M. G. et al. “CO₂ capture over amine-functionalized MCM-41 and SBA-15: Exploratory analysis and decision tree classification of past data”, Journal of CO₂ Utilization, v. 31, p. 27-42, 2019.

For sample B (zirconium and cerium hydroxide) the same absorptions were found by infrared spectroscopy. However, no binding of cerium was identified, since cerium absorbs in the region around 560 cm−1, being confused with the absorption of H₂O. Hydrated zirconia has also been identified by X-ray crystallography. As the literature teaches, samples of zirconium hydroxide have high reactivity with CO₂ due to the presence of hydroxyls on its surface.

The results of capture at 25° C. for solids A and B were respectively equal to 128 and 89 mg_{CO2}/g, with enthalpies of 776 and 536 J/g. This increase in enthalpy can be attributed to the creation of oxygen vacancies, increasing capture and enthalpy. The high sample area favors the generation of vacancies and the anchoring of Pt, as evidenced by chemisorption of hydrogen, due to the high metallic dispersion found, equal to 100%.

The literature teaches that, if CO₂ could occupy the oxygen vacancies, as the process is endothermic and relatively stable, it is necessary to conduct desorption using high temperatures as described by PAN, Y. X. et al. “Effects of Hydration and Oxygen Vacancy on CO₂ Adsorption and Activation on β-Ga₂O₃ (100)”, Langmuir, v. 26, p. 5551-5558, 2010.

An adaptation of the capture method was conducted to verify if all the CO₂ had been desorbed, then, through successive captures with CO₂ and desorption with argon at 25° C. As an example, the analysis was performed with microporous coal and dolomite mineral.

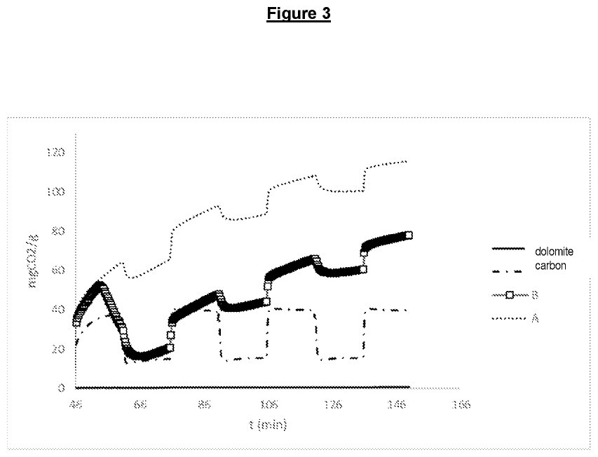

It is observed that for the carbon sample, the amount of desorbed CO₂ is equal to that adsorbed, while for samples A and B, the desorbed amount increases during the cycles, indicating that CO₂ removal was not as effective in each cycle, possibly by the formation of more stable carbon species. However, even so, it was still possible to increase the amount captured, reaching values of 115 mg CO₂/g. In FIG. 3, comparative results with microporous carbon and dolomite mineral, whose capture activity can be considered null.

Infrared analysis of samples A and B after capture identified bands referring to the hydroxyl group of water (3,222 and 1,630 cm−1), hydroxyl bonded to zirconia (1,548 and 1,339 cm−1), C—O bond (1,086 cm−1), cerium was identified in the sample by cerium nitrate (877 cm−1). As the sample was not calcinated, only dried, the cerium precursor had not been decomposed, which explains the absence of cerium oxides. In addition, the oxygen vacancies, which would lead to a high dispersion of Pt, in this case the value of 72% was found, are due to the species of Ce⁺³, which explains a lower adsorption of CO₂ by sample B, FIG. 3.

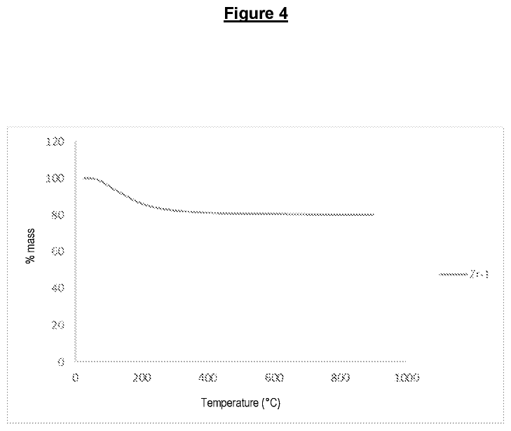

Care must be taken at very high desorption temperatures, if the objective is to use this CO₂ for other purposes, since the material also loses mass through dehydroxylation. The loss of mass evaluated by thermogravimetric analysis (with argon from 25 to 900° C.), showed that at a temperature of 100° C. (pre-treatment of the sample in CO₂ capture) there occurs a loss of 4.5% of mass for sample A, not greatly affecting the adsorbent inventory, if adsorption/desorption is carried out at low temperatures, and loss of more than 10% m/m may occur at desorption temperatures above 200° C., FIG. 4.

Furthermore, CO₂ capture may be impaired, since the crystalline transformation of zirconium hydroxide to zirconium oxide occurs at temperatures above 420° C., observed through DSC peaks referring to crystalline transformations at 435° C. (A), affecting the CO₂ capture capacity. Therefore, this type of material has several disadvantages in relation to materials with different Si/Metal ratios, despite their compatible performance.

It is considered that capture (adsorption/desorption steps) should preferably be used at low temperatures, while mesoporous silica is a more stable material as it has been calcinated at temperatures above 500° C. For example, at a temperature of 400° C., the mass loss of the SBA-15 Mg and SBA-15 Cu samples was around 8-9.0% m/m.

It should be noted that, although the present invention has been described with respect to the attached drawings, modifications and adaptations can be made by those skilled in the art, depending on the specific situation, but provided that it is within the inventive scope defined herein.

1. A process of synthesis of silica-based adsorbents comprising:
a) dissolving a poly(ethylene glycol)-poly(propylene glycol)-poly(ethylene glycol) surfactant in block (P123) having a Mw=5800, in a 37% HCl solution with a pH range between 0.15 and 1.5 for 0.5-4 hours at 35-40° C. to form a dissolution;
b) adding to the dissolution a metal precursor, in an aqueous medium, in an amount of 1 mol tetraethoxysilane (TEOS) for 0.02-3.0 mol of the metal precursor to form a first mixture;
c) after 30 minutes adding to the first mixture TEOS to form a second mixture and keeping the second mixture at 35-40° C. for 20-24 hours;
d) transferring the second mixture to a sealed reactor to conduct a hydrothermal treatment, placing the hydrothermal treated material inside an oven adjusted to 100-120° C., and keeping the hydrothermal treated material in this condition for 20-48 hours;
e) cooling the hydrothermal treated material to room temperature, and then filtering and washing with distilled water and a 2% v/v solution of hydrochloric acid in ethanol to collect a purified material; and
f) after the washing step, drying the purified material at 35-60° C. for 6-24 hours and calcinating at 500-550° C. using a rate of 1-5° C./min for 4-6 hours.

2. The process of synthesis of silica-based adsorbents of claim 1, wherein the metal of the metal precursor is chosen from Cu, Mg, Al, Mn, Ni, Sn, Zr, Co, or Pt.

3. The process of synthesis of silica-based adsorbents of claim 1, wherein the metal precursor is a chloride, nitrate, or isopropoxide.

4. A silica-based adsorbent obtained by the process of claim 1, wherein the adsorbent has an Si/M ratio between 8 to 60, adsorption at 25° C. in the range of 40 to 112 mg 002/g ads, area in the range of 520 to 840 m²/g, dp in the range of 60-92 angstrom/pore volume*cm³/g, silanol density in the range from 4.8 to 24 SiOH*nm² and enthalpy at 25° C. in the range from 607 to 1,938 J/g.

5. A carbon dioxide capture process, comprising the application of the silica-based adsorbent obtained by the process of claim 1.

6. A carbon dioxide capture process, comprising the application of the silica-based adsorbent of claim 4.
